(19) United States
(12) Patent Application Publication
(10) Pub. No.: US 2011/0234533 A1
(43) Pub. Date: Sep. 29, 2011

(54) Capacitive Touch Panel

(75) Inventor: Jane HSU, Guishan Township (TW)

(73) Assignee: DERLEAD INVESTMENT LTD., Taipei (TW)

(21) Appl. No.: 13/053,907

(22) Filed: Mar. 22, 2011

(30) Foreign Application Priority Data
Mar. 26, 2010 (TW) 099205285

(51) Int. Cl. G06F 3/045

(52) U.S. Cl. 345/174; 178/18.06

(57) ABSTRACT

The present invention is related to a capacitive touch panel having a substrate having multiple conductive wires mounted on a top of the substrate. The capacitive touch panel further has a hard film layer mounted on the top of the substrate and having an opaque ink layer mounted on a periphery of a top of the hard film layer, the opaque ink layer covering the conductive wires. The present invention mounts the ink layer directly on the hard film layer without using any conventional top cover layer and adhering layer so that the manufacturing processes are simplified and the material costs are reduced. Furthermore, a total thickness of the capacitive touch panel is decreased.

### BACKGROUND OF THE INVENTION

1. Field of the Invention

The present invention relates to a capacitive touch panel that avoids mounting a top cover layer and an adhering layer thereon.

2. Description of Related Art

Touch panels are classified into capacitive type, resistive type, acoustic wave type and infrared type, etc. according to the principles of touch panel technologies. Capacitive touch panels have advantages of waterproof, scrape-proof and high transparency, etc. and therefore are mainly employed in high end products.

With reference to FIG. 5, a conventional single substrate type capacitive touch panel (30) has a substrate (31) and a hard film layer (41) mounted on one surface thereof to prevent a conductive glass layer on the substrate (31) from being scraped. Furthermore, because conductive wires in the capacitive touch panel (30) for outputting signals from touched points are opaque, a top cover layer (42) is further mounted on a top of the capacitive touch panel (30). An adhering layer (43) is attached between the top cover layer (42) and the hard film layer (41). An opaque ink layer (44) is coated on a bottom surface of the top cover layer (42) and corresponds to the area of the conductive wires in the capacitive touch panel (30) so that a user does not see the conductive wires during operation. However, applying the top cover layer (42) and adhering layer (43) complicates the manufacturing processes, increases the cost of material and raises the total thickness of the touch panel product. Accordingly, the touch panel product does not fulfill the demand for thinness. Therefore, the conventional capacitive touch panels still need further improvement.

### SUMMARY OF THE INVENTION

Because the way of the conventional capacitive touch panel hiding the conductive wires increases the costs and fails to thin the products, the present invention intends to improve the structure of a capacitive touch panel that avoids mounting a top cover layer and an adhering layer thereon.

To achieve the aforementioned goal, the present invention provides a capacitive touch panel having a substrate having multiple conductive wires mounted on a top of the substrate. Significantly, the capacitive touch panel further has a hard film layer mounted on the top of the substrate and having an opaque ink layer mounted on a periphery of a top of the hard film layer, the opaque ink layer covering the conductive wires.

The present invention mounts the ink layer directly on the hard film layer without using any conventional top cover layer and adhering layer so that the manufacturing processes are simplified and the material costs are reduced. Furthermore, a total thickness of the capacitive touch panel is decreased.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a capacitive touch panel in accordance with the present invention;

FIG. 2 is a top view of the first embodiment of the capacitive touch panel;

FIG. 3 is an exploded perspective view of a second embodiment of the capacitive touch panel in accordance with the present invention;

FIG. 4 is a top view of the second embodiment of the capacitive touch panel; and

FIG. 5 is an exploded perspective view of a conventional capacitive touch panel in accordance with the prior art.

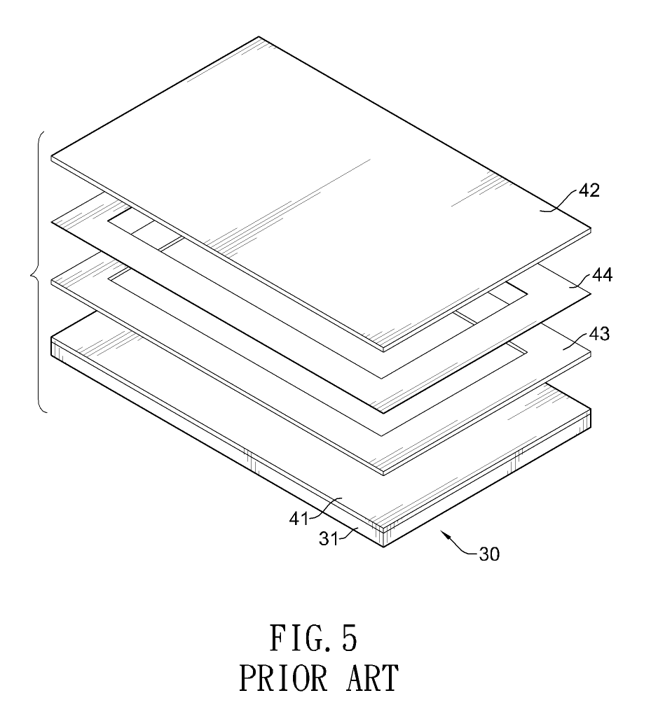

### DETAILED DESCRIPTION OF THE PREFERRED EMBODIMENT

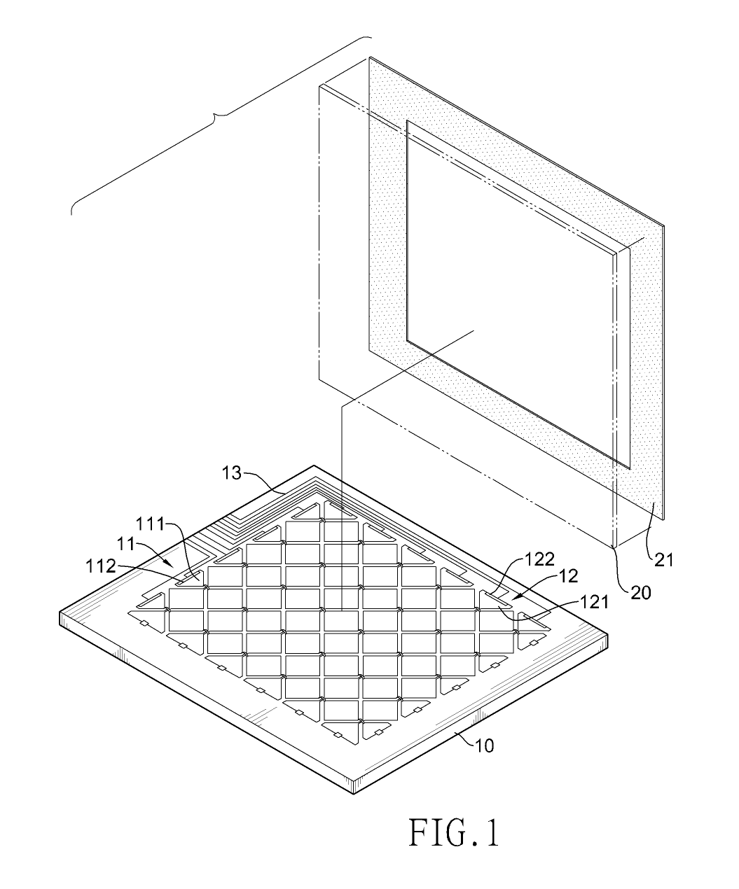

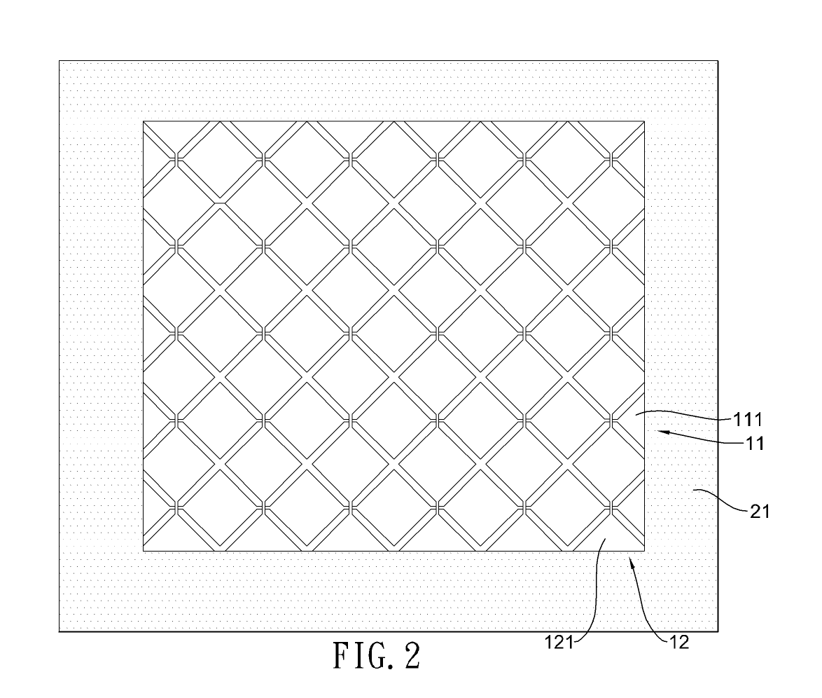

With reference to FIGS. 1 and 2, a capacitive touch panel in accordance with the present invention may be projected capacitive type or surface capacitive type according to principles of the touch panel. A first embodiment of the capacitive touch panel being a projected capacitive type comprises a substrate (10) and a hard film layer (20).

The substrate (10) is transparent and has multiple first sensing layers (11) and multiple second sensing layers (12) staggered and mounted on a top of the substrate (10). The first sensing layers (11) are parallel and arranged along an axis. Each first sensing layer (11) has multiple first sensing areas (111) that are made of indium tin oxide (ITO) and connected in series. The second sensing layers (12) are located on portions of the substrate (10) on which the first sensing layers (11) are not located. The second layers (12) are parallel and arranged along another axis. Each second sensing layer (20) has multiple second sensing areas (121) that are made of indium tin oxide (ITO) and connected in series. In the first embodiment, the first and second sensing areas (111, 121) are rhombuses. Each of the first and second layers (11, 12) has a connecting element (112, 122) mounted on an end of the first or second layer (11, 12). The connecting elements (112, 122) are opaque. Furthermore, the substrate (10) has multiple conductive wires (13) mounted on the top of the substrate (10). A number of the conductive wires (13) corresponds to a number of the first sensing layers (11) and second sensing layers (12). Each conductive wire (13) has two ends, one end is connected to one of the connecting elements (112, 122) of the first sensing layers (11) and second sensing layers (12) and the other end extends to a side of the substrate (10).

The hard film layer (20) may be made of silicon dioxide (SiO₂), is mounted on the top of the substrate (10) and has an opaque ink layer (21) mounted on a periphery of a top of the hard film layer (20). The ink layer (21) covers the connecting elements (112, 122) of the first sensing areas (111) and second sensing areas (121) and the conductive wires (13).

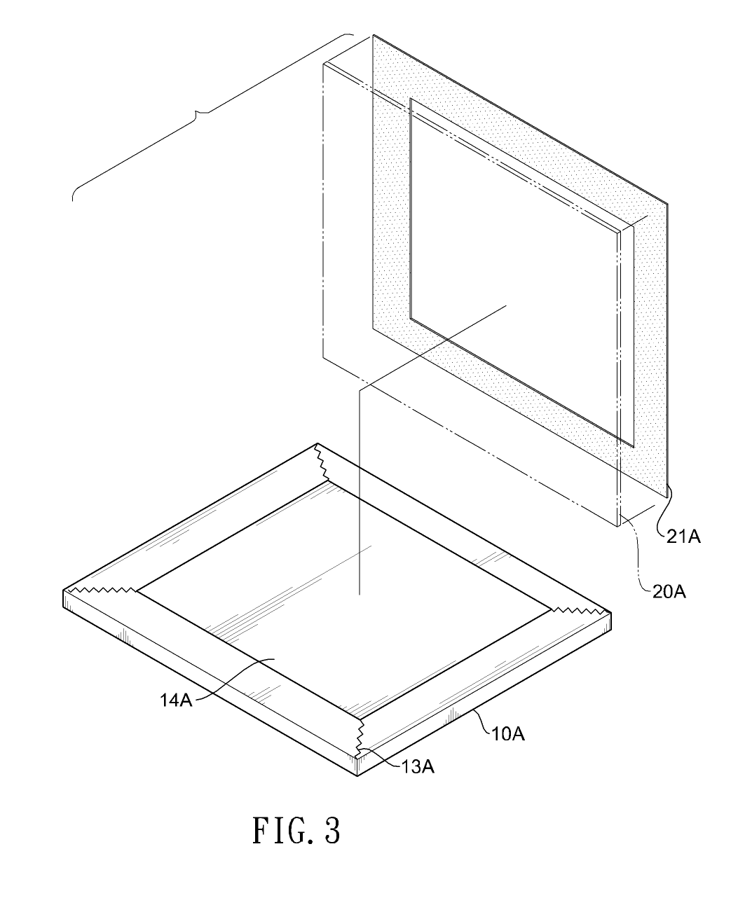

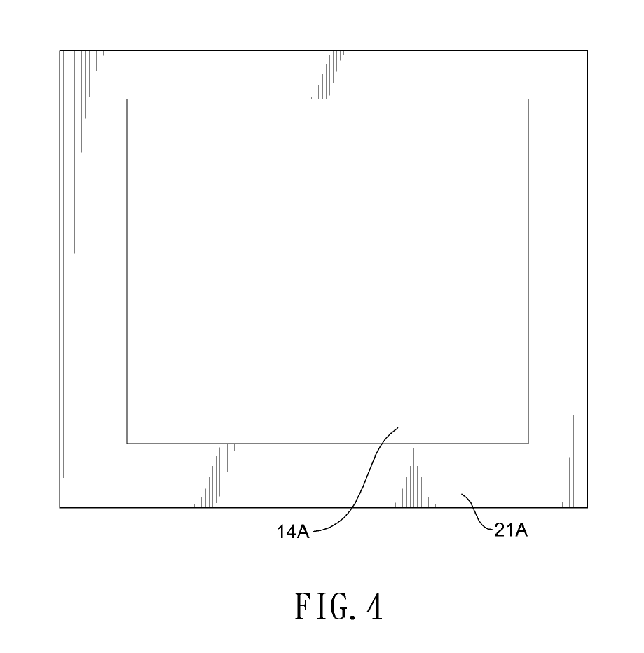

With reference to FIGS. 3 and 4, a second embodiment of the capacitive touch panel being a surface capacitive type comprises a substrate (10A) and a hard film layer (20A).

The substrate (10A) is transparent and has an integral sensing layer (14A) and four conductive wires (13A) mounted on a top of the substrate (10A). The sensing layer (14A) may be made of indium tin oxide (ITO). Each conductive wire (13A) has two ends, one end is connected to a corner of the sensing layer (14A) and the other end extends to a side of the substrate (10A). The hard film layer (20A) may be made of silicon dioxide (SiO₂), is mounted on the top of the substrate (10A) and has an opaque ink layer (21A) mounted on a periphery of a top of the hard film layer (20A). The ink layer (21A) covers the conductive wires (13A).

With reference to FIGS. 2 and 4, when observed from the top of the present invention, the ink layer (21, 21A) on the top of the hard film layer (20) is opaque and may hide the conductive wires (13, 13A) and connecting elements (112, 122). The present invention mounts the ink layer (21, 21A) directly on the hard film layer (20, 20A) without using any conventional top cover layer and adhering layer so that the manufacturing processes are simplified and the material costs are reduced. Furthermore, a total thickness of the capacitive touch panel is decreased.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A capacitive touch panel comprising a substrate having multiple conductive wires mounted on a top of the substrate, the capacitive touch panel characterized in that: the capacitive touch panel further comprises:
a hard film layer mounted on the top of the substrate and having an opaque ink layer mounted on a periphery of a top of the hard film layer, the opaque ink layer covering the conductive wires.

2. The capacitive touch panel as claimed in claim 1, wherein the substrate has multiple first sensing layers and multiple second sensing layers staggered and mounted on the top of the substrate; the first sensing layers are arranged along an axis; the second sensing layers are located on portions of the substrate on which the first sensing layers are not located, the second layers are arranged along another axis; a number of the conductive wires corresponds to a number of the first and second sensing layers; each conductive wire has two ends, one end is connected to one of the first and second sensing layers and the other end extends to a side of the substrate.

3. The capacitive touch panel as claimed in claim 2, wherein
each of the first sensing layers has multiple first sensing areas connected in series and a connecting element mounted on an end of the first second layer;
each of the second sensing layers has multiple second sensing areas connected in series and a connecting element mounted on an end of the second layer;
one end of each conductive wire is connected to one of the connecting elements of the first and second sensing layers; and
the opaque ink layer further covers the connecting elements of the first sensing layers and second sensing layers.

4. The capacitive touch panel as claimed in claim 3, wherein the hard film layer is made of silicon dioxide.

5. The capacitive touch panel as claimed in claim 3, wherein the first and second sensing areas of the first and second sensing layers are made of indium tin oxide.

6. The capacitive touch panel as claimed in claim 4, wherein the first and second sensing areas of the first and second sensing layers are made of indium tin oxide.

7. The capacitive touch panel as claimed in claim 1, wherein the substrate has a sensing layer and four conductive wires mounted on the top of the substrate; each conductive wires has two ends, one end is connected to a corner of the sensing layer and the other end extends to a side of the substrate.

8. The capacitive touch panel as claimed in claim 7, wherein the hard film layer is made of silicon dioxide.

9. The capacitive touch panel as claimed in claim 7, wherein the sensing layer is made of indium tin oxide.

10. The capacitive touch panel as claimed in claim 8, wherein the sensing layer is made of indium tin oxide.
